(19) United States
(12) Patent Application Publication
(10) Pub. No.: US 2010/0315156 A1
(43) Pub. Date: Dec. 16, 2010

(54) VOLATAGE BANDGAP REFERENCE CIRCUIT

(76) Inventor: Wen-Chang Cheng, Taoyuan City (TW)

Correspondence Address: NORTH AMERICA INTELLECTUAL PROPERTY CORPORATION, P.O. BOX 506, MERRIFIELD, VA, 22116, US

(21) Appl. No.: 12/485,905

(22) Filed: Jun. 16, 2009

(51) Int. Cl. G05F 3/02

(52) U.S. Cl. 327/539

(57) ABSTRACT

A voltage bandgap reference circuit includes a voltage keeping circuit, for keeping a first voltage at a first point and a second voltage at a second point to a constant level; a first NMOSFET, having a drain terminal coupled to the first point and a source terminal coupled to a first specific voltage level; and a second NMOSFET, having a drain terminal coupled to the second point and a source terminal coupled to the first specific voltage level.

### BACKGROUND OF THE INVENTION

1. Field of the Invention

The present invention relates to a voltage bandgap reference circuit, and particularly relates to a voltage bandgap reference circuit utilizing NMOSFETs with dynamic threshold voltage.

2. Description of the Prior Art

In many electronic systems, a voltage bandgap reference circuit is utilized to compensate voltage variation caused from different temperatures, such that a constant voltage can be provided by the voltage bandgap reference circuit. The voltage bandgap reference circuit always utilizes PMOSFETS and resistors to compensate the voltage variations from different temperatures. However, N-well of the PMOSFET is not isolated from peripheral circuits, such that PMOSFETs are easily affected and temperature compensation efficiency may decreases.

### SUMMARY OF THE INVENTION

One embodiment of the present application discloses a voltage bandgap reference circuit, which comprises: a voltage keeping circuit, for keeping a first voltage at a first point and a second voltage at a second point to a constant level; a first NMOSFET, having a drain terminal coupled to the first point and a source terminal coupled to a first specific voltage level; and a second NMOSFET, having a drain terminal coupled to the second point and a source terminal coupled to the first specific voltage level.

Since the structure of the NMOSFET is different from which of the PMOSFET, the problem disclosed in the prior art can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram illustrating a voltage bandgap reference circuit according to a preferred embodiment of the present application.

FIG. 2 is a cross-sectional view of the NMOSFET utilized in the embodiment of FIG. 1.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

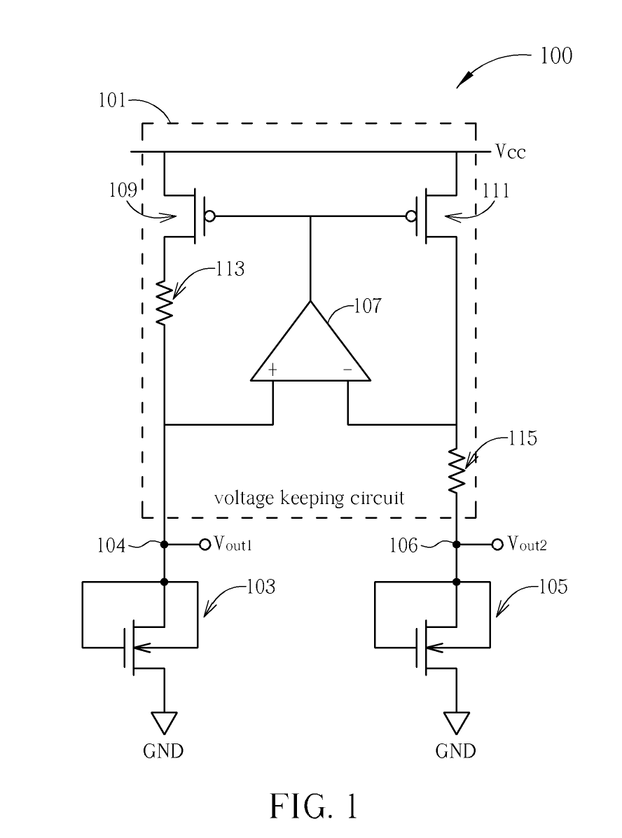

FIG. 1 is a circuit diagram illustrating a voltage bandgap reference circuit 100 according to a preferred embodiment of the present application. It should be noted that the devices and structures disclosed below are only for example and do not mean to limit the scope of the present application. As shown in FIG. 1, the voltage bandgap reference circuit 100 includes a voltage keeping circuit 101, a first NMOSFET 103 and a second NMOSFET 105. The voltage keeping circuit 101 keeps a first voltage Vₒᵤₜ₁ at a first point 104 and a second voltage Vₒᵤₜ₂ at a second point 106 to a constant level. The first NMOSFET 103 has a drain terminal coupled to the first point 104 and a source terminal coupled to a first specific voltage level (a ground voltage level GND in this embodiment). The second NMOSFET 105 has a drain terminal coupled to the second point 106 and a source terminal coupled to the first specific voltage level.

In one embodiment, the voltage keeping circuit 101 includes: a comparator 107, a first PMOSFET 109, a second PMOSFET 111, a first resistor 113 and a second resistor 115. The first PMOSFET 109 has a source terminal coupled to a second specific voltage level V_{cc}. The second PMOSFET 111 has a source terminal coupled to the second specific voltage level V_{cc}. The comparator 107 has an output coupled to gate terminals of the first PMOSFET 109 and the second PMOSFET 111. The first resistor 113 has a first terminal coupled to a drain terminal of the first PMOSFET 109 and a second terminal coupled to a first input terminal of the comparator 107 and the first point 104. The second resistor 115 has a first terminal coupled to a drain terminal of the second PMOSFET 111 and a second input terminal of the comparator 107, and has a second terminal coupled to the second point 106.

In this embodiment, the gate terminal and the body of the first NMOSFET 103 are coupled to the first point 104. Also, the gate terminal and the body of the second NMOSFET 105 are coupled to the second point 106. By this way, the first NMOSFET 103 and the second NMOSFET 105 are dynamic threshold voltage NMOSFETs.

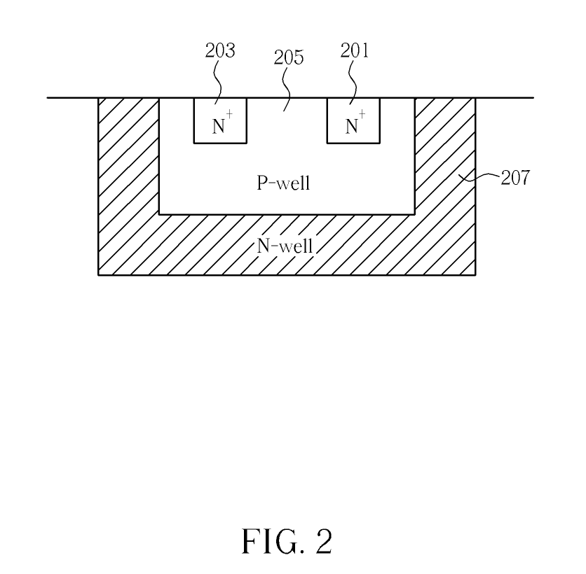

FIG. 2 is a cross-sectional view of the NMOSFET utilized in the embodiment of FIG. 1. Please refer to FIG. 2 to understand the advantage of the present application more clearly. As shown in FIG. 2, the N+ regions 201 and 203 of NMOSFETs are located in a P well region 205, which is surrounded by an N-well region 207.

By this way, P well can be isolated from peripheral circuits, therefore the problem disclosed in the prior art can be avoided.

Those skilled in the art will readily observe that numerous modifications and alterations of the device and method may be made while retaining the teachings of the invention.

What is claimed is:

1. A voltage bandgap reference circuit, comprising:
a voltage keeping circuit, for keeping a first voltage at a first point and a second voltage at a second point to a constant level;
a first NMOSFET, having a drain terminal coupled to the first point and a source terminal coupled to a first specific voltage level; and
a second NMOSFET, having a drain terminal coupled to the second point and a source terminal coupled to the first specific voltage level.

2. The voltage bandgap reference circuit of claim 1, wherein the voltage keeping circuit comprises:
a first PMOSFET, having a source terminal coupled to a second specific voltage level;
a second PMOSFET, having a source terminal coupled to the second specific voltage level;
a comparator, having an output coupled to gate terminals of the first PMOSFET and the second PMOSFET;
a first resistor, having a first terminal coupled to a drain terminal of the first PMOSFET, and a second terminal coupled to a first input terminal of the comparator and the first point; and
a second resistor, having a first terminal coupled to a drain terminal of the second PMOSFET and a second input terminal of the comparator, and a second terminal coupled to the second point.

3. The voltage bandgap reference circuit of claim 1, wherein a gate terminal and a body of the first NMOSFET are coupled to the first point.

4. The voltage bandgap reference circuit of claim 1, wherein a gate terminal and a body of the second NMOSFET are coupled to the second point.

5. The voltage bandgap reference circuit of claim 1, wherein the first NMOSFET and the second NMOSFET are dynamic threshold voltage NMOSFETs.

6. The voltage bandgap reference circuit of claim 1, wherein the first specific voltage level is a ground voltage level.

7. A voltage bandgap reference circuit, comprising:
a voltage keeping circuit, for keeping a first voltage at a first point and a second voltage at a second point to a constant level, wherein the voltage keeping circuit comprises:
a first PMOSFET, having a source terminal coupled to a second specific voltage level;
a second PMOSFET, having a source terminal coupled to the second specific voltage level;
a comparator, having an output coupled to gate terminals of the first PMOSFET and the second PMOSFET;
a first resistor, having a first terminal coupled to a drain terminal of the first PMOSFET, and a second terminal coupled to a first input terminal of the comparator and the first point, and
a second resistor, having a first terminal coupled to a drain terminal of the second PMOSFET and a second input terminal of the comparator, and a second terminal coupled to the second point;
a first NMOSFET, having a drain terminal coupled to the first point, a source terminal coupled to a first specific voltage level, a gate terminal and a body are coupled to the first point; and
a second NMOSFET, having a drain terminal coupled to the second point and a source terminal coupled to the first specific voltage level.

8. The voltage bandgap reference circuit of claim 7, wherein a gate terminal and a body of the first NMOSFET are coupled to the first point.

9. The voltage bandgap reference circuit of claim 8, wherein the second NMOSFET has a gate terminal and a body both coupled to the second point.

10. The voltage bandgap reference circuit of claim 8, wherein the first NMOSFET and the second NMOSFET are dynamic threshold voltage NMOSFETs.

11. The voltage bandgap reference circuit of claim 8, wherein the first specific voltage level is a ground voltage level.
